(19) United States
(12) Patent Application Publication
(10) Pub. No.: US 2023/0332741 A1
(43) Pub. Date: Oct. 19, 2023

(54) Pressure Vessel and Pressure Vessel System

(71) Applicant: Bayerische Motoren Werke Aktiengesellschaft, Muenchen (DE)

(72) Inventor: Michael RUF, Muenchen (DE)

(21) Appl. No.: 18/027,324

(22) PCT Filed: Sep. 3, 2021
(86) PCT No.: PCT/EP2021/074337

§ 371 Date: Mar. 20, 2023

(30) Foreign Application Priority Data
Sep. 21, 2020 (DE) 10 2020 124 545.9

(51) Int. Cl. F17C 1/06; F17C 1/16

(52) U.S. Cl. CPC F17C 1/06; F17C 1/16; F17C 2223/035; F17C 2260/011

(57) ABSTRACT

A pressure vessel with a braided wall surrounds an interior in which an overpressure can be generated. The wall has a degree of coverage that is greater than 1 up to an overpressure, which maximally corresponds to a specified threshold, and a degree of coverage that is less than 1 when the threshold is exceeded. In this manner, gaseous fuel can be discharged slower than in a bursting event. A pressure vessel system having at least one such pressure vessel is disclosed.

### BACKGROUND AND SUMMARY

The technology disclosed herein relates to a pressure vessel and to a pressure vessel system having at least one such pressure vessel.

Pressure vessels are typically used in motor vehicles or other mobile or stationary installations in order for the latter to be supplied with gaseous fuel. One potential failure of such a pressure vessel is bursting in which large quantities of gaseous fuel can escape in a short time.

It is a preferred object of the technology disclosed herein to minimize or to eliminate at least one disadvantage of a previously known solution or to propose an alternative solution. It is in particular a preferred object of the technology disclosed herein to minimize potential damage in the event of a failure of a pressure vessel. Further preferred objects may be derived from the advantageous effects of the technology disclosed herein. The objects are achieved by the subject matter of the independent patent claims. The dependent claims represent preferred design embodiments.

The technology disclosed herein relates to a pressure vessel, comprising a braided wall assembly that surrounds an interior in which a positive pressure is able to be formed. The wall assembly, up to a positive pressure which at most corresponds to a predetermined threshold value, has a coverage ratio of more than 1. The wall assembly, at a positive pressure which exceeds the predetermined threshold value, has a coverage ratio of less than 1. As a result of such an embodiment it can be achieved that breakages between fibers are generated in a targeted manner when the threshold value is exceeded, leakages being created along the wall assembly as a result thereof. This results in a slower pressure equalization than in bursting procedures. The consequences of an excessive pressure are thus significantly mitigated. This applies in particular in comparison to pressure vessels known from the prior art, in which bursting typically arises before the coverage ratio could drop below the value of 1.

The wall assembly can in particular have one or a plurality of fibers which are suitably braided in order to surround the interior. The wall assembly is typically pressure-tight at least up to the threshold value so that the wall assembly can withstand a corresponding positive pressure. The positive pressure is typically defined as the pressure in the interior minus a pressure outside the wall assembly. The pressure outside the wall assembly can be, for example, the normal ambient pressure, the latter typically being approximately 1 bar. This positive pressure in the form of a pressure differential is typically relevant for the stability of the wall assembly so that a higher internal pressure may also prevail if a higher pressure is prevalent outside the wall assembly, for example.

A braided wall assembly can in particular be configured from fibers which are brought into a desired shape in particular by braiding. This can take place by braiding over a preform, for example.

In principle, a braided wall assembly expands under a prevalent positive pressure, specifically more heavily the higher the positive pressure. In typical pressure vessels which have, for example, an elongate shape with a round, oval or similar cross section, such an expansion can include in particular an increase in length and an increase in the diameter. The coverage ratio also changes as a result, the coverage ratio fundamentally dropping during expansion of the wall assembly. A coverage ratio is fundamentally understood to be the ratio of the area covered by the fibers, while taking into account multiple coverages, to the surface of the wall assembly. At a coverage ratio of 1, the entire surface of the wall assembly is thus covered, without there being any multiple coverages. Multiple coverages occur at a coverage ratio of more than 1, wherein at a coverage ratio of 1.2, for example, 20% of the surface may have double coverage. At a coverage ratio of less than 1, parts of the wall assembly are not covered by fibers so that intermediate spaces are created. This can typically increasingly lead to breakages between fibers, the latter in the present case being consciously initiated so that a dissipation of positive pressure takes place in a slower and more controlled manner than during bursting.

The wall assembly, in particular in the absence of a positive pressure, can have a coverage ratio of at least 1.05, or at least 1.1. It has been demonstrated that such a coverage ratio in typical embodiments at a positive pressure of 0, i.e. at the same internal pressure and external pressure, leads to the coverage ratio becoming less than 1 in the case of threshold values that are typically to be used. The coverage ratio can have, for example, a value of 1 at the threshold value.

It can be provided in particular that the wall assembly in the absence of positive pressure has a coverage ratio of at most 1.1, at most 1.15, or at most 1.2. At maximum coverage ratios of this type it has likewise been demonstrated that a coverage ratio of less than 1 arises when exceeding the threshold value at threshold values that are typically to be used.

All lower limits mentioned can in particular be combined with all upper limits mentioned of the coverage ratio so as to form a respective interval.

The predetermined threshold value can be, for example, at least 1400 bar. This corresponds to a basic design of pressure vessels to be expected. The predetermined threshold value can also be, for example, at least 1575 bar, this likewise corresponding to a typical basic design of pressure vessels. If the threshold value is to be higher than a design pressure, the threshold value can have a value between 1500 bar and 1650 bar, or a value between 1650 bar and 1800 bar, for example.

The pressure vessel can in particular be configured as a linerless pressure vessel. In this way, there is in particular no liner and typically also no other material located between the wall assembly and the interior so that the gaseous fuel stored in the interior comes directly into contact with the wall assembly. As a result, the functionality, described further above, of the targeted, slower discharge of the gaseous fuel can be advantageously achieved because no liner prevents any potential escape of gas.

The braided wall assembly can in particular be configured as a permeation barrier for gaseous fuel stored in the interior. An additional liner can in particular be dispensed with as a result. The braided wall assembly can be produced from fibers, for example, and/or be impregnated with one or a plurality of thermoplastic and/or thermosetting plastics materials or any other material such that the wall assembly per se already ensures that the escape of gaseous fuel, potentially while permitting minor leakage, is prevented.

The braided wall assembly can in particular be impregnated with one or a plurality of thermoplastic plastics materials and/or with one or a plurality of thermosetting plastics materials. Materials of this type can also be referred to as matrix materials. As a result, the effect of the braided wall assembly as a permeation barrier can be improved, and/or the stability can be increased. Elastomers or multi-layer composites which are composed of identical or dissimilar types of plastics materials can in principle also be used as matrix material for the wall assembly, in particular for a fiber-reinforced plastics material that forms the wall assembly.

The thermoplastic and/or thermosetting plastic material(s), or else the other materials mentioned in the previous paragraph, can partially form a permeation barrier for gaseous fuel stored in the interior in particular at a coverage ratio of less than 1. As a result, certain shortfalls of the coverage ratio below the value of 1 can initially be tolerated, in particular until the previously described ruptures between fibers arise. Once the ruptures between fibers arise, the stability of the wall assembly, at least locally, is typically no longer sufficient in order to prevent an escape of gaseous fuel. This is desirable in the technology described herein, as has already been described further above.

The wall assembly can in particular be braided from fibers between which intermediate spaces are created at a coverage ratio of less than 1. Intermediate spaces of this type can in particular represent weak spots in the event of the exit of gaseous fuel already described, the gaseous fuel being able to exit at the weak spots.

The intermediate spaces can in particular be covered by one or a plurality of thermoplastic and/or thermosetting plastics materials. The other materials already mentioned further above can also be used accordingly.

The intermediate spaces can in particular be configured as predetermined breaking points. As a result, the already described functionality can be assisted in particular in the event of a desired exit of gaseous fuel, for example after a desired breakage between fibers.

The technology described herein furthermore relates to a pressure vessel system having a plurality of pressure vessels as described herein. In terms of the pressure vessels, all described variants may be used. The pressure vessel system can in particular serve for supplying a motor vehicle or any other mobile or stationary unit with gaseous fuel, the latter being able to be used in a gas-operated internal combustion engine or a fuel cell, for example.

The coverage ratio can in particular be adjusted in the production of a pressure vessel in the braiding process, wherein different factors can be influenced in a targeted manner. The latter include, for example, the number of braiding threads, the thickness of the braiding thread, the braiding rate or the advancing rate of a braiding core and/or the revolving speed of the braiding bobbins on the radial braider. Mechanisms such as, for example, a thread spreader ahead of the thread deposition, for example having a compressed-air supply, can additionally also be used for influencing the coverage ratio.

A pressure vessel serves in particular for storing fuel which is gaseous at ambient conditions. The pressure vessel, or the pressure vessel system, can be used in particular in a motor vehicle which is operated with compressed natural gas (also referred to as CNG) or liquefied natural gas (also referred to as LNG) or with hydrogen. The pressure vessel system can be fluidically connected to at least one energy converter which is specified to convert the chemical energy of the fuel into other forms of energy. The pressure vessel can in particular be configured as a composite overwrapped pressure vessel. The pressure vessel can be a cryogenic pressure vessel or a high-pressure gas vessel, for example. High-pressure gas vessels are configured to permanently store fuel at ambient temperatures at a nominal working pressure (also referred to as NWP) of at least 350 bar positive pressure (=positive pressure relative to the atmospheric pressure) or at least 700 bar positive pressure. A cryogenic pressure vessel is suitable for storing the fuel at the afore-mentioned operating pressures even at temperatures that are significantly below (for example more than 50K or more than 100K) the operating temperature of the motor vehicle.

In the pressure vessel disclosed herein a pressure relief valve can in particular be dispensed with because the effects in the event of positive pressure are minimized and thus easier to manage.

In other words, it has been recognized that the external wall, or the wall assembly, of the pressure vessel typically fails in the event of a failure of a pressure vessel, this potentially leading to a sudden escape of the stored medium. The pressure equalization between the environment and the medium taking place in the process can lead to a blast wave and to damage to the environment. Carbon fiber-reinforced plastics material (CRP) is used as the material for the external wall, or wall assembly, for example. Customary manufacturing methods for the pressure vessels include fiber-wrapping or fiber-braiding on a winding core/braiding core. A liner which guarantees the tightness and the permeation barrier for the pressure vessel can be located in the interior of the pressure vessel, such an embodiment being referred to as a type IV pressure vessel. Furthermore, there are type V pressure vessels in which the matrix material of the CRP layer has such positive permeation properties that a liner for the pressure vessel is no longer required.

For safety reasons, pressure vessels may be provided with pressure relief valves. However, it may also be desirable for such pressure relief valves to be dispensed with. For this case, oversizing of vessel walls while taking into account corresponding safety factors can take place, for example, so as to withstand even particularly high positive pressures. Such oversizing as well as a pressure relief valve can be typically dispensed with by means of the technology disclosed herein, because the consequences of positive pressure are easier to manage, as has already been described.

In pressure vessels which are produced by the braiding method, the braided structure can be adjusted in a targeted manner by machine parameters and manufacturing process parameters. This means that, above all, the number of braiding threads and the depositing width for the individual braiding threads can be influenced in a targeted manner. In this way, the coverage ratio of the braiding core by the braiding threads can be influenced. As soon as the braiding core is completely covered by threads and the braiding pattern does not have any “holes”, the coverage ratio is 1. Should there be more or fewer braiding threads than required for complete coverage, the coverage ratio is more than or less than 1. If the machine parameters and manufacturing process parameters are now kept constant, and the diameter of the braiding core is decreased or increased, the coverage ratio increases or decreases. Pressure vessels, by virtue of the elastic properties of the materials of the pressure vessel wall or wall assembly, are subject to a clearly measurable expansion in the axial and radial direction during operation. In the process, the pressure vessel continuously expands from the non-pressurized state to that of bursting, and the diameter increases in the process. In terms of braided pressure vessels, this means that the forces between the braiding threads continuously increase such that the braided structure has the desire to reduce its coverage ratio. As soon as the coverage ratio has reached the value of 1, high forces which cannot be solely supported by the matrix material arise between the fibers, the matrix material having a very minor strength in comparison to the fibers. The matrix then breaks, which is also referred to as breakage between fibers.

In type V pressure vessels, the matrix material above all has the task of keeping the pressure vessel tight. This is no longer the case in the event of breakages between fibers, and the stored gas can escape through cracks that have been created. The braided type V pressure vessel is now in particular to be conceived such that the braided structure in the operating range has a coverage ratio of more than 1. At the same time, the braided structure is to be conceived such that the pressure vessel when reaching the actual bursting/design pressure has expanded such that the braided structure has a coverage ratio of less than 1, and leakages which initiate a smoother pressure equalization than failure by bursting are created along the entire diameter as a result of breakages between fibers.

The technology described herein will now be described by means of the drawings.

### BRIEF DESCRIPTION OF THE DRAWINGS

FIG. 1 shows a pressure vessel;

FIG. 2 shows a fragment from a wall assembly at a coverage ratio of 1; and

FIG. 3 shows a fragment from a wall assembly at a coverage ratio of less than 1.

### DETAILED DESCRIPTION OF THE DRAWINGS

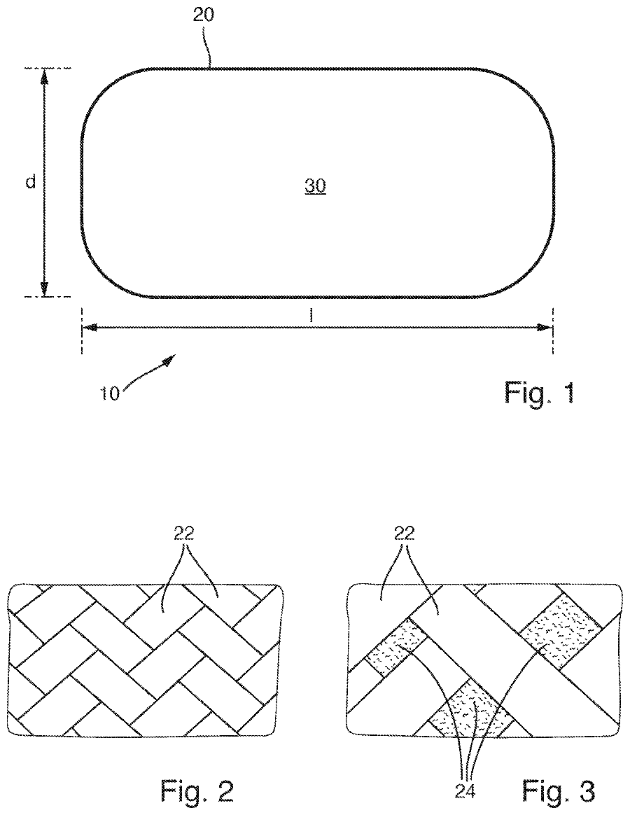

FIG. 1 shows purely schematically a pressure vessel 10. The latter is formed substantially by a wall assembly 20 which surrounds an interior 30. The interior 30 is configured to store gaseous fuel under high pressure, as a result of which a positive pressure of the interior 30 in comparison to the surrounding atmosphere is established. The wall assembly 20 prevents the gaseous fuel from escaping. The wall assembly 20 is configured from braided fibers which presently are impregnated with a thermosetting plastics material. Such a thermosetting plastics material may also be referred to as resin, or be a resin.

The pressure vessel 10 has a length 1 and a diameter d. These are values which are variable depending on the prevailing positive pressure in the interior 30. For example, the pressure vessel 10 can be made in the absence of a prevailing positive pressure, as a result of which an associated length 1 and an associated diameter d are established. If the positive pressure in the interior 30 is increased, the length 1 and the diameter d increase. This also affects the fibers of the wall assembly 20, which are explained further below with reference to FIGS. 2 and 3.

The pressure vessel 10 has even further components such as, for example, a tank connection valve for fueling and/or for retrieving gaseous fuel. However, these components are not illustrated in FIG. 1 because they are not relevant in terms of understanding the technology disclosed herein.

FIG. 2 shows fibers 22 of the wall assembly 20 at a coverage ratio of 1, or else somewhat more than 1. As shown, the fibers 22 here bear against one another such that no intermediate spaces whatsoever are created, the fibers 22 thus completely surrounding the interior 30. The pressure vessel 10 in this state typically has a high degree of stability which reliably keeps the gaseous fuel in the interior 30, in particular up to a design pressure.

FIG. 3 shows a fragment from the wall assembly 20 at a coverage ratio of less than 1, the latter arising in particular when the positive pressure in the interior 30 exceeds a predefined threshold value. As a result of the already described expansion of the length 1 and the diameter d of the pressure vessel 10, intermediate spaces 24 which are not covered by fibers 22 are created between the fibers 22. Located therein is only a thermosetting plastics material as a matrix material, which offers the gaseous fuel less resistance in relation to any potential exiting. In a situation of this type, breakages between fibers typically arise, as a result of which the stability of the wall assembly 20 is locally reduced at some locations. In this case, the intermediate spaces 24 serve in particular as predetermined breaking points, wherein gaseous fuel is discharged from the interior 30 in a targeted manner, specifically in particular at a significantly slower rate than in the event of bursting. As a result, the effects of a positive pressure that exceeds a design can be significantly minimized.

For reasons of legibility, the term “at least one” has occasionally been omitted for simplification. To the extent that a feature of the technology disclosed herein is described in the singular or indeterminately (e.g. the/a pressure vessel, the/a fiber, etc.), the plurality thereof is intended also simultaneously to be conjointly disclosed (e.g. the at least one pressure vessel, the at least one fiber, etc.).

The above description of the present invention is used only for illustrative purposes and is not used for the purpose of limiting the invention. Different variants and modifications are possible within the scope of the invention, without departing from the scope of the invention and the equivalents of the latter.

### LIST OF REFERENCE SIGNS

10 Pressure vessel
20 Wall assembly
22 Fibers
24 Intermediate spaces
30 Interior
1 Length
d Diameter

1-12. (canceled)

13. A pressure vessel, comprising:
a braided wall assembly that surrounds an interior in which a positive pressure is able to be formed, wherein
the wall assembly, up to a positive pressure which at most corresponds to a predetermined threshold value, has a coverage ratio of more than 1, and
the wall assembly, at a positive pressure which exceeds the predetermined threshold value, has a coverage ratio of less than 1.

14. The pressure vessel according to claim 13, wherein
the wall assembly in the absence of positive pressure has a coverage ratio of at least 1.05.

15. The pressure vessel according to claim 13, wherein
the wall assembly in the absence of positive pressure has a coverage ratio of at least at least 1.1.

16. The pressure vessel according to claim 13, wherein
the wall assembly in the absence of positive pressure has a coverage ratio of at most 1.1.

17. The pressure vessel according to claim 13, wherein
the wall assembly in the absence of positive pressure has a coverage ratio of at most 1.15.

18. The pressure vessel according to claim 13, wherein
the wall assembly in the absence of positive pressure has a coverage ratio of at most 1.2.

19. The pressure vessel according to claim 13, wherein
the predetermined threshold value is at least 1400 bar.

20. The pressure vessel according to claim 13, wherein
the pressure vessel is configured as a linerless pressure vessel.

21. The pressure vessel according to claim 13, wherein
the braided wall assembly is configured as a permeation barrier for gaseous fuel stored in the interior.

22. The pressure vessel according to claim 13, wherein
the braided wall assembly is impregnated with one or a plurality of thermoplastic and/or thermosetting plastics materials.

23. The pressure vessel according to claim 22, wherein
the thermoplastic and/or thermosetting plastics material, at a coverage ratio of less than 1, partially form a permeation barrier for gaseous fuel stored in the interior.

24. The pressure vessel according to claim 13, wherein
the wall assembly is braided from fibers between which intermediate spaces are created at a coverage ratio of less than 1.

25. The pressure vessel according to claim 23, wherein
the intermediate spaces are covered by one or a plurality of thermoplastic and/or thermosetting plastics materials.

26. The pressure vessel according to claim 25, wherein
the intermediate spaces are configured as predetermined breaking points.

27. A pressure vessel system comprising a plurality of pressure vessels according to claim 13.
